(19) United States
(12) Patent Application Publication
(10) Pub. No.: US 2018/0308058 A1
(43) Pub. Date: Oct. 25, 2018

(54) JOINT OPTIMIZATION AND ASSIGNMENT OF JOB RECOMMENDATIONS

(71) Applicant: LinkedIn Corporation, Sunnyvale, CA (US)

(72) Inventors: Krishnaram Kenthapadi, Sunnyvale, CA (US); Fedor Vladimirovich Borisyuk, Sunnyvale, CA (US)

(21) Appl. No.: 15/493,786

(22) Filed: Apr. 21, 2017

(51) Int. Cl. G06Q 10/10; G06Q 50/00

(52) U.S. Cl. CPC G06Q 10/1053; G06Q 50/01

(57) ABSTRACT

An on-line social network system includes or is in communication with a recommendation system that is configured to assign jobs to members while taking into account the relevance of a job for a given member as well as the relevance of the same job for other members. The objective of said optimization is to maximize the total sum of respective relevance scores generated for member/job pairs for jobs that get selected for presentation to members. The optimization objective is constrained by the maximum number of job recommendations desirable for each member profile and may also be constrained by the maximum number of member recommendations desirable for each job posting.

### TECHNICAL FIELD

This application relates to the technical fields of software and/or hardware technology and, in one example embodiment, to system and method to generate joint optimization and assignment of job recommendations to members in an on-line social network system.

### BACKGROUND

An on-line social network may be viewed as a platform to connect people and share information in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member profile may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member. An on-line social network may store include one or more components for matching member profiles with those job postings that may be of interest to the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to generate joint optimization and assignment of job recommendations to members in an on-line social network system may be implemented;

FIG. 2 is block diagram of a system to generate joint optimization and assignment of job recommendations to members in an on-line social network system, in accordance with one example embodiment;

FIG. 3 is a flow chart illustrating a method to generate joint optimization and assignment of job recommendations to members in an on-line social network system, in accordance with an example embodiment; and

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system to generate joint optimization and assignment of job recommendations to members in an on-line social network system is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrases “an on-line social networking application,” “an on-line social network system,” and “an on-line social network service” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). The profiles are stored in a database and represented by a set of features and also associated with respective web pages in the on-line social network system. A user may be permitted to add or edit information in their member profile by means of a profile user interface (UI) that includes a plurality of fields suitable for collecting input information. A member profile representing a member in an on-line social network system includes information items generated based on input provided via the profile UI. A member profile representing a member in an on-line social network system is also associated with information items generated based on events detected in the on-line social network system that indicate activity of the associated member in the on-line social network system—the so-called behavior data.

A member profile may include or be associated with links that indicate the member's connection to other members of the social network. A member profile may also include or be associated with comments or recommendations from other members of the on-line social network, with links to other network resources, such as, e.g., publications, etc. The profile information of a social network member profile may include various information such as, e.g., the name of a member, current and previous geographic location of a member, current and previous employment information of a member, information related to education of a member, etc.

The on-line social network system also maintains information about various companies, as well as so-called job postings. A job posting, also referred to as merely “job” for the purposes of this description, is an electronically stored entity that includes information that an employer may post with respect to a job opening. The information in a job posting may include, e.g., industry, company, job position, required and/or desirable skills, geographic location of the job, etc.

Member profiles and job postings are represented in the on-line social network system by feature vectors. The features in the feature vectors may represent, e.g., a job industry, a professional field, a job title, a company name, professional seniority, geographic location, etc.

The on-line social network system includes a recommendation system configured to select one or more job postings for presentation to a member based on criteria that indicates that a particular job posting is likely to be of interest to the member. The likelihood of a job being of interest to a member, in one embodiment, is expressed by the probability of the member applying for the associated job. The criteria that indicates that a particular job posting is likely to be of interest to the member, in one embodiment, is associated with a relevance value.

When a new login session is initiated for a member in the on-line social network system, the recommendation system generates respective relevance values for pairs comprising a member profile representing the member in the on-line social network system and a job posting. The relevance values, in one embodiment, are generated using a statistical model (referred to as a relevance model for the purposes of this description). A relevance value (also referred to as a relevance score), in one embodiment, is expressed as probability of a particular member applying for a particular job and can be generated using a statistical model, such as, e.g., logistic regression. A relevance model can be learned using previously collected data that reflects interactions of members with job postings in the on-line social network system and data that is indicative of members' applying for a job after having been presented with the associated job posting.

Those job postings, for which their respective relevance values for a particular member profile are equal to or greater than a predetermined threshold value, are selected for potential presentation to that particular member, e.g., on the news feed page of the member or on some other page provided by the on-line social networking system. Each item in a presentation set of job recommendations is a reference to a job posting that is associated with a relevance value generated for that job posting with respect to the particular member. The items in the presentation set of job recommendations may be ordered based on their respective associated relevance values.

While the recommendation system generates job recommendations for members, the recommendation system can also be configured to identify, with respect to a particular job posting, those members that are potentially qualified for the job. Thus it can be said that the recommendation system generates job recommendations with respect to a member profile and also generates member recommendations with respect to a job posting. Member recommendations for a job postings are selected based on their respective fitness values. A fitness value generated for a member profile with respect to a job posting indicates how qualified the member represented by the member profile is for the job represented by the job posting. A fitness value (also referred to as a fitness score), in one embodiment, is expressed as probability of a particular member being hired for a particular job and can be generated using a statistical model (referred to as a fitness model for the purposes of this description), such as, e.g., logistic regression. A fitness model can be learned using previously collected data that is indicative of members' features expressed in their respective member profiles and the status of the members' being hired for various jobs represented by respective job postings.

Those member profiles, for which their respective fitness values for a particular job posting are equal to or greater than a predetermined threshold value, are selected for potential presentation to a job poster (a user associated with providing of the job posting to the on-line social network system), e.g., via email or push notification, etc. Each item in a resulting presentation set of member profiles is a reference to a member profile.

It will be noted that, for the purposes of this description, when discussing items in a presentation set of job recommendations or items in a presentation set of profiles, the phrase “member” or “member profile” refers to a reference to a member profile, and the phrase “job” or “job posting” refers to a reference to a job posting.

As the number of jobs potentially relevant to a member may be too large for the presentation real estate and the member's attention span, the recommendation system uses a cap value r(m) (termed a jobs cap value) that limits the maximum number of jobs that can be included in a presentation set of job recommendations for a particular member profile m. For the purposes of this description, a member profile is sometimes referred to as merely member. Also, the number of member profiles to be recommended with respect to a particular job posting j is limited by a so-called candidates cap value, s(j) such that the number of items that can be included in a presentation set of profiles is less than or equals to that value. Each item in a presentation set of job recommendations is a reference to a job posting that is associated with a relevance value generated for that job posting with respect to the particular member. The items in the presentation set of job recommendations may be ordered based on their respective associated relevance values. Each item in a presentation set of profiles generated for a particular job posting is a reference to a member profile that is associated with a fitness value generated for that member profile with respect to the particular job postings. The items in the presentation set of profiles may be ordered based on their respective associated fitness values.

When jobs are being recommended to members, the goal is to show to a member t the member would want to see; ideally, the jobs selected by the recommendation system would be those jobs that the member would not only look at but also apply for. As explained above, the selection of jobs that are to be shown to a member entails generating so-called relevance scores for member-job pairs.

One approach for determining which job postings to show to a member is to identify a set of candidate jobs for a subject member (those jobs that pass a certain minimal threshold of relevance, which may be, e.g., the jobs in the same industry and the current employer listed in the subject member's profile), calculate respective relevance scores for all these jobs with respect to the subject member, and pick a certain number of the jobs with the highest relevance scores for presentation to the subject member.

It may be desirable to not show the same job to too many members, as it may be more difficult for an employer to make a choice among the job candidates when there are too many applications. It may also diminish each applicant's chances of getting hired for the job.

A further approach for determining which job postings to show to a member is a so-called simultaneous optimization-based assignment, which takes into account the relevance of a job for a given member as well as the relevance of the same job for other members.

The objective of said optimization is to maximize the total sum of respective relevance scores generated for member/job pairs for jobs that get selected for presentation to members. Such optimization problem can be expressed as Equation (1) below.

$$max {\sum }_{m ∈ M}^{ } {\sum }_{j ∈ J}^{ } [ x ( m , j ) * α ( m , j ) ] \qquad Equation ( 1 )$$

where M denotes the set of members m, and J denotes the set of jobs j, α(m, j) is the relevance score generated for a pair comprising member m and job j, and x(m, j) is an indicator variable that takes value 1 if job j is assigned to member m, and 0 otherwise. If a job posting j has not been included in a set for potential presentation to a member represented by a member profile m (based on the relevance score generated for that member profile with respect to that job posting being equal to or greater than a predetermined threshold value), the relevance score for that pair, (m, j), is set to zero.

The optimization objective is constrained by the maximum number of job recommendations, r(m), desirable for each member profile m, which can be expressed by Equation (2) shown below.

Σ_{j∈j}x(m,j)≤r(m) Equation (2)

The optimization objective is also constrained by the maximum number of member recommendations, s(j) desirable for each job posting j, which can be expressed by Equation (3) shown below.

Σ_{m∈M}x(m,j)≤s(j) Equation (3)

The optimization problem expressed by Equation (1) is solved by computing, for all the (m, j) pairs, respective binary variables x(m, j), such that the total relevance score, defined as the sum of relevance scores of assigned (member, job) pairs, is maximized. A (member, job) pair is said to be assigned if the job from the pair has been selected for presentation to the member from the pair. In other words, the value of an x(m, j) variable determines whether the job j is selected for recommendation and presentation to the member m.

Simultaneous assignment and optimization of this nature may prove to be beneficial since it takes into account how relevant a job is to a member as compared to how relevant the job is for other members to whom the job could be recommended. In particular, such assignment ensures that the same job does not get recommended to a very large set of members, as not all interested members may have a reasonable likelihood of actually obtaining the job based on their professional experience and qualification.

In operation, the recommendation system takes, as input, (1) the maximum number of job recommendations, r(m), desirable for each member profile m, (2) the maximum number of member recommendations, s(j) desirable for each job posting j, and (3) the time period, deltaT, between two adjacent joint computations.

At time t, for each member profile m, the recommendation system determines C(m), a ranked set of job recommendations j, along with the respective relevance scores α(m, j) as follows. It first obtains a preliminary set of job postings (also referred to as a set of candidate job postings), using, e.g., the feature comparison approach. The recommendation system then generates respective relevance values for each job posting in the set using the relevance model and eliminates from that set those job postings, for which the relevance score is equal to or less than a predetermined threshold value. The recommendation system then returns this resulting set of job postings with corresponding relevance scores α(m, j).

The recommendation system then executes one or more operations for solving the optimization problem expressed by Equation (1) in order to compute, for all the (m, j) pairs from the set of members M and the set of jobs J, respective binary variables x(m, j), such that the total relevance score, defined as the sum of relevance scores of assigned (member, job) pairs, is maximized.

The optimization problem expressed by Equation 1 can be solved utilizing, e.g., the optimal algorithm or, e.g., the greedy algorithm. The process of executing of the optimal algorithm comprises reducing the above optimization problem to the maximum weighted bipartite matching problem, which admits an efficient polynomial time solution. A maximum weighted bipartite matching is defined as a matching where the sum of the values of the edges in the matching have a maximal value. Finding such a matching can be referred to as the assignment problem. Given an instance of the above problem, the recommendation system forms a complete weighted bipartite graph G=(V, E) as follows. Associate r(m) nodes u_(m,1), . . . , u_{m,r(m)} with each member m in M, and associate s(j) nodes v_{j,1}, . . . , v_{j, s(j)} with each job j in J. Create an edge between every member node copy and every job node copy. Weight of the edge (u_{m, *}, v_{j, *}) is set to α(m, j) for all r(m)*s(j) such edges; that is, each of the edges joining a member m to job j has the same weight, equal to the corresponding relevance score α(m, j). The recommendation system performs operations for solving the maximum weighted bipartite matching problem optimally in polynomial time, and maps the obtained matching to the corresponding solution to the above problem where the obtained matching corresponds to the set of x(m, j) from M and J having the value 1 indicating that the job j is assigned to member m.

Another example approach to solving the optimization problem expressed by Equation 1 is the greedy algorithm. The process of executing of the greedy algorithm comprises sorting the α (m, j) values in decreasing order and parsing these values. At each step, the greedy algorithm picks the highest α (m, j) value such that a job can still be assigned to member m (that is, less than r(m) jobs have so far been assigned to m) and then assigns job j to member m. This process ends when either all members have been assigned the maximum number of jobs or there are no more jobs to be assigned.

For the purpose of computational efficiency, in some embodiments, the recommendation system can partition member profiles and job postings based, on e.g., on industry, job function, geographic location, etc. or a combination of these dimensions, and consider separate optimizations within each partition.

The process of simultaneous optimization and assignment of jobs to members can be repeated at intervals of deltaT in order to take into account the temporal nature of members and jobs (new members/members who updated their profiles/new jobs/expired jobs/edited jobs). Between a computation and the next one, the job recommendations are computed for each member separately, using a relevance model.

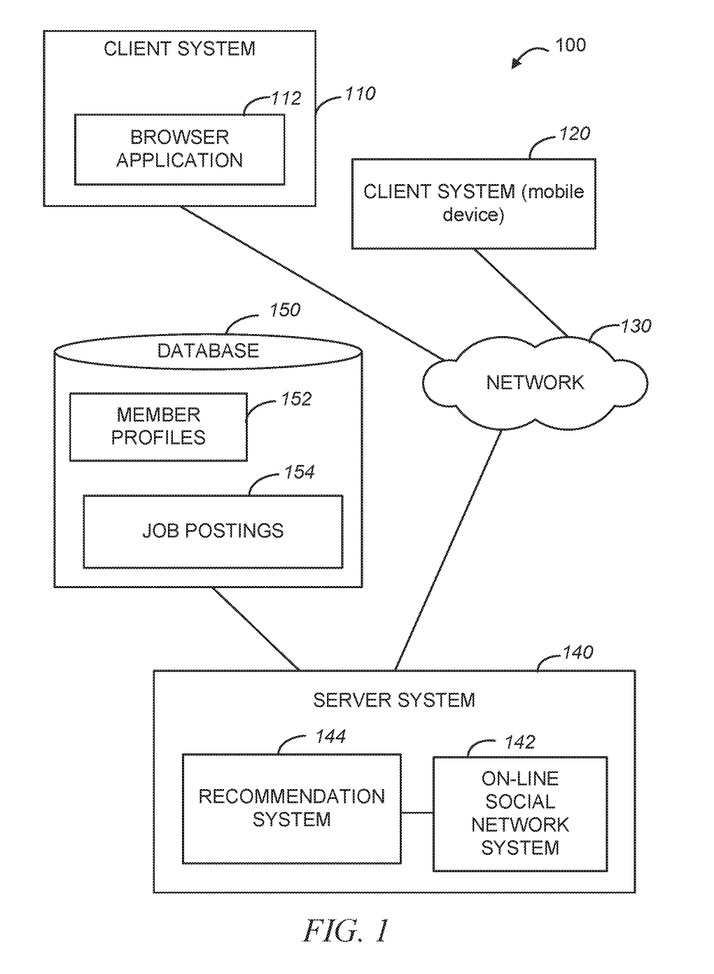

An example recommendation system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152. The database 150 also stores job postings 154.

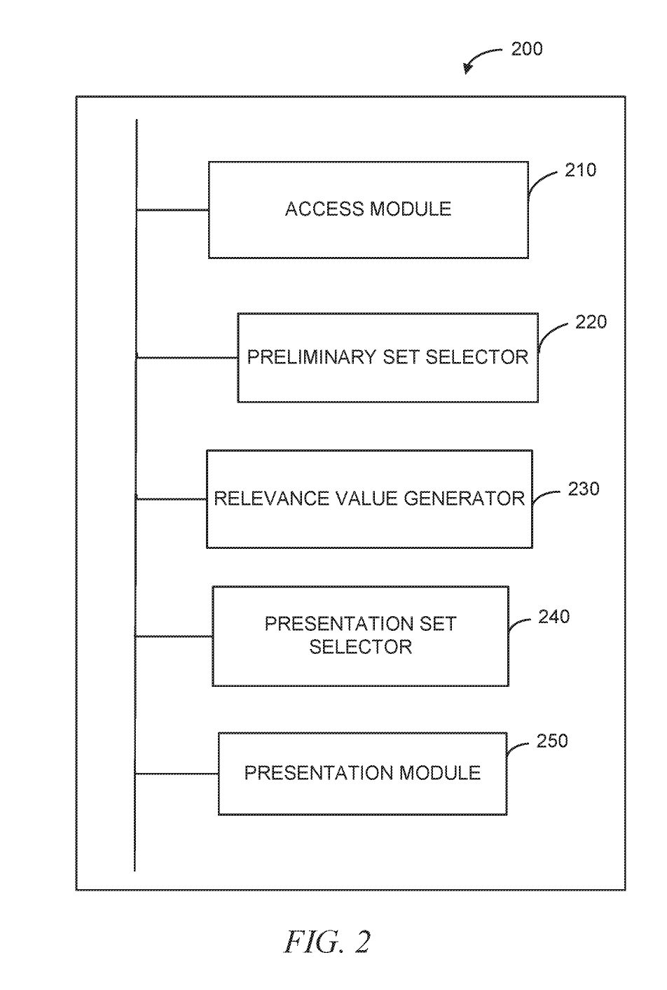

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a recommendation system 144. The recommendation system 144 is configured to perform simultaneous optimization-based assignment of job postings to member profiles, while taking into account the relevance of a job for a given member as well as the relevance of the same job for other members, using the methodologies described above. An example of an on-line social network system is LinkedIn®. An example recommendation system, which corresponds to the recommendation system 144 is illustrated in FIG. 2.

FIG. 2 is a block diagram of a system 200 to generate joint optimization and assignment of job recommendations to members in the on-line social network system 142 of FIG. 1. As shown in FIG. 2, the system 200 includes an access module 210, a preliminary set selector 220, a relevance value generator 230, and a presentation module 250.

The access module 210 is configured to access member profiles and job postings stored in the databases 150 of FIG. 1. The preliminary set selector 220 is configured to select a set of candidate job postings for a subject member profile. As mentioned above, a set of candidate job postings may be obtained, using, e.g., the feature comparison approach.

The relevance value generator 230 is configured to generate, for each job posting in the set of candidate job postings, an associated relevance value indicating a likelihood that a member represented by a subject member profile applies for a job represented by a job posting.

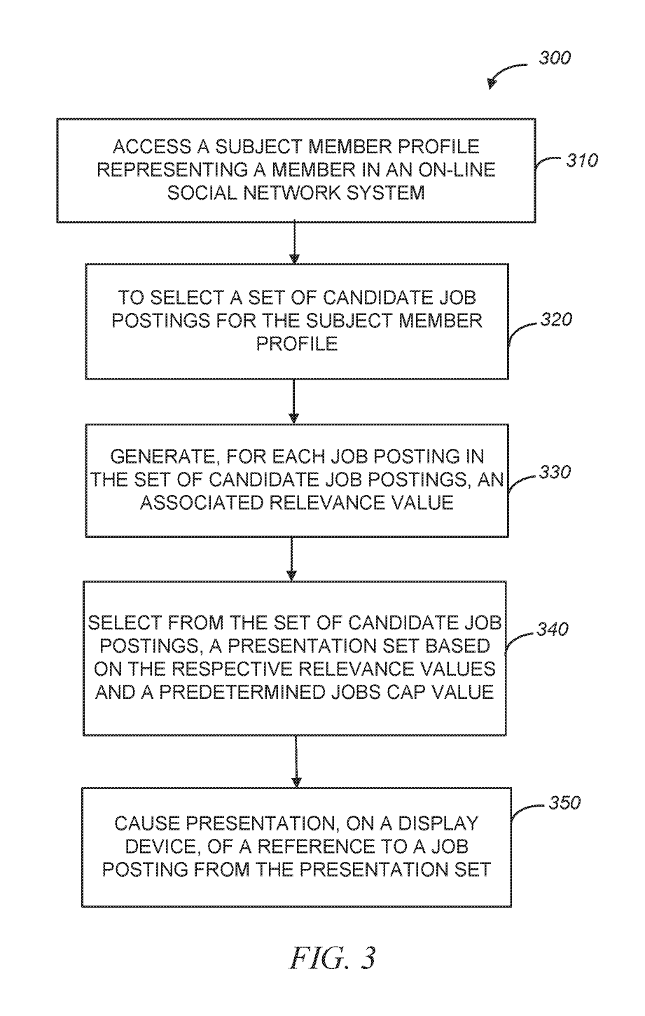

The presentation set selector 240 is configured to select, from the set of candidate job postings, a presentation set based on respective relevance values generated for each job posting from the larger set of job postings with respect to each member profile from the set of member profiles and also based on a predetermined jobs cap value indicating the maximum number of job postings that is to be selected for presentation to a member represented by a profile from the set of member profiles. In one embodiment, the presentation set selector 240 is configured to perform operations for solving the optimization problem expressed by Equation (1) discussed above, using, e.g., the maximum weighted bipartite matching algorithm or the greedy algorithm. The presentation module 250 is configured to cause presentation, on a display device, of a reference to a job posting from the presentation set. Some operations performed by the system 200 may be described with reference to FIG. 3.

FIG. 3 is a flow chart of a method 300 to generate joint optimization and assignment of job recommendations to members in the on-line social network system 142 of FIG. 1. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the access module 210 of FIG. 2 access a subject member profile stored in the databases 150 of FIG. 1. The preliminary set selector 220 of FIG. 2 select a set of candidate job postings for the subject member profile at operation 320. At operation 330, the relevance value generator 230 of FIG. 2 generates, for each job posting in the set of candidate job postings, an associated relevance value indicating a likelihood that a member represented by the subject member profile applies for a job represented by the job posting.

At operation 340, the presentation set selector 240 of FIG. 2 selects, from the set of candidate job postings, a presentation set based on the respective relevance values and a jobs cap value indicating the maximum number of job postings that is to be selected for presentation to a member. As explained above, the presentation set selector 230 of FIG. 2 performs operations for solving the optimization problem expressed by Equation (1), using, e.g., the maximum weighted bipartite matching algorithm or the greedy algorithm. The presentation module 250 of FIG. 2 causes presentation, on a display device, of references to job postings from the presentation set, at operation 350.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

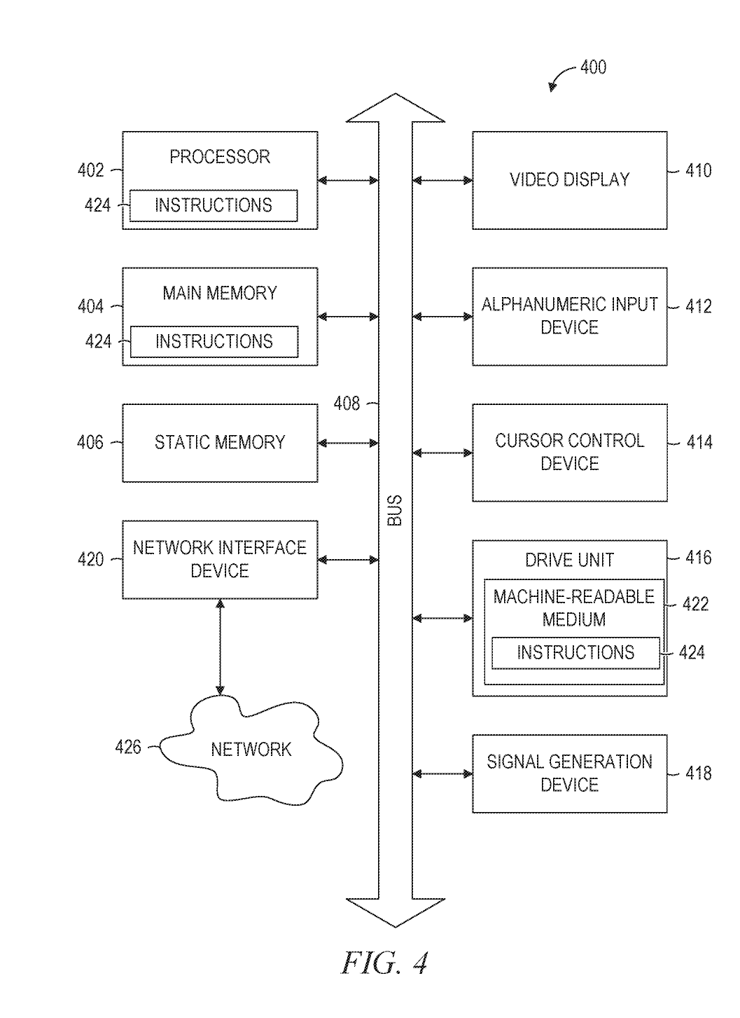

FIG. 4 is a diagrammatic representation of a machine in the example form of a computer system 400 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 404. The computer system 400 may further include a video display unit 410 (e.g., a liquid crystal display (LCD) or a cathode ray tube (CRT)). The computer system 400 also includes an alpha-numeric input device 412 (e.g., a keyboard), a user interface (UI) navigation device 414 (e.g., a cursor control device), a disk drive unit 416, a signal generation device 418 (e.g., a speaker) and a network interface device 420.

The disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, with the main memory 404 and the processor 402 also constituting machine-readable media.

The software 424 may further be transmitted or received over a network 426 via the network interface device 420 utilizing any one of a number of well-known transfer protocols (e.g., Hyper Text Transfer Protocol (HTTP)).

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### MODULES, COMPONENTS AND LOGIC

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to generate joint optimization and assignment of job recommendations to members in an on-line social network system has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
accessing a subject member profile representing a member in an on-line social network system, the subject member profile is from a set of member profiles;
using at least one processor, selecting a set of candidate job postings for the subject member profile, the set of candidate job postings is from a larger set of job postings;
for each job posting in the set of candidate job postings, generating an associated relevance value indicating a likelihood that a member represented by the subject member profile applies for a job represented by the job posting;
from the set of candidate job postings, using at least one processor, selecting a presentation set based on:
respective relevance values generated for each job posting from the larger set of job postings with respect to each member profile from the set of member profiles, and
a predetermined jobs cap value indicating the maximum number of job postings that is to be selected for presentation to a member represented by a profile from the set of member profiles; and
causing presentation, on a display device, of a reference to a job posting from the presentation set.

2. The method of claim 1, wherein the selecting of the presentation set comprises:
generating, for each pair comprising a member profile from the set of member profiles and a job posting from the larger set of job postings, a binary value indicating whether the associated job posting is assigned to the associated member profile; and
including, in the presentation set, those job postings, for which the binary value with respect to the subject member profile is indicative of positive assignment.

3. The method of claim 2, wherein the generating of respective binary values for each pair comprising a member profile from the set of member profiles and a job posting from the larger set of job postings indicating whether the associated job posting is assigned to the associated member comprises:
constructing a weighted bipartite graph with nodes representing member profiles from the set of member profiles and job postings from the larger set of job postings, an edge associated with a node representing a member profile and a node representing a job posting having a weight reflecting a relevance value generated for a par comprising that member profile and that job posting; and
calculating a maximum weighted bipartite matching with respect to the constructed weighted bipartite graph.

4. The method of claim 3, wherein a number of nodes representing the subject member profile in the constructed weighted bipartite graph equals the predetermined jobs cap value.

5. The method of claim 3, wherein a number of nodes representing a particular job posting in the constructed weighted bipartite graph equals a predetermined candidates cap value.

6. The method of claim 1, wherein the selecting of the presentation set comprises utilizing greedy algorithm with respect to a set of relevance values generated for each pair comprising a member profile from the set of member profiles and a job posting from the larger set of job postings.

7. The method of claim 1, wherein each member profile in the set of member profiles is associated with a particular industry.

8. The method of claim 1, wherein each job posting in the larger set of job postings is associated with a particular geographic location.

9. The method of claim 1, wherein each member profiles from the set of member wherein profiles is associated with a profile UI configured to display and to collect data about the associated member.

10. The method of claim 1, wherein each job posting in the larger set of job postings is an electronic publication in a structured form.

11. A computer-implemented system comprising:
an access module, implemented using at least one processor, to access a subject member profile representing a member in an on-line social network system, the subject member profile is from a set of member profiles;
a preliminary set selector, implemented using at least one processor, to select a set of candidate job postings for the subject member profile, the set of candidate job postings is from a larger set of job postings;
a relevance value generator, implemented using at least one processor, to generate, for each job posting in the set of candidate job postings, an associated relevance value indicating a likelihood that a member represented by the subject member profile applies for a job represented by the job posting;
a presentation set selector, implemented using at least one processor, to select from the set of candidate job postings, a presentation set based on:
respective relevance values generated for each job posting from the larger set of job postings with respect to each member profile from the set of member profiles, and
a predetermined jobs cap value indicating the maximum number of job postings that is to be selected for presentation to a member represented by a profile from the set of member profiles; and
a presentation module, implemented using at least one processor, to cause presentation, on a display device, of a reference to a job posting from the presentation set.

12. The system of claim 11, wherein the presentation set selector is to:
generate, for each pair comprising a member profile from the set of member profiles and a job posting from the larger set of job postings, a binary value indicating whether the associated job posting is assigned to the associated member profile; and
include, in the presentation set, those job postings, for which the binary value with respect to the subject member profile is indicative of positive assignment.

13. The system of claim 12, wherein the generating of respective binary values for each pair comprising a member profile from the set of member profiles and a job posting from the larger set of job postings indicating whether the associated job posting is assigned to the associated member comprises:
constructing a weighted bipartite graph with nodes representing member profiles from the set of member profiles and job postings from the larger set of job postings, an edge associated with a node representing a member profile and a node representing a job posting having a weight reflecting a relevance value generated for a par comprising that member profile and that job posting; and
calculating a maximum weighted bipartite matching with respect to the constructed weighted bipartite graph.

14. The system of claim 13, wherein a number of nodes representing the subject member profile in the constructed weighted bipartite graph equals the predetermined jobs cap value.

15. The system of claim 13, wherein a number of nodes representing a particular job posting in the constructed weighted bipartite graph equals a predetermined candidates cap value.

16. The system of claim 11, wherein the selecting of the presentation set comprises utilizing greedy algorithm with respect to a set of relevance values generated for each pair comprising a member profile from the set of member profiles and a job posting from the larger set of job postings.

17. The system of claim 11, wherein each member profile in the set of member profiles is associated with a particular industry.

18. The system of claim 11, wherein each job posting in the larger set of job postings is associated with a particular geographic location.

19. The system of claim 11, wherein each member profiles from the set of member wherein profiles is associated with a profile UI configured to display and to collect data about the associated member.

20. A machine-readable non-transitory storage medium having instruction data executable by a machine to cause the machine to perform operations comprising:
accessing a subject member profile representing a member in an on-line social network system, the subject member profile is from a set of member profiles;
using at least one processor, selecting a set of candidate job postings for the subject member profile, the set of candidate job postings is from a larger set of job postings;
for each job posting in the set of candidate job postings, generating an associated relevance value indicating a likelihood that a member represented by the subject member profile applies for a job represented by the job posting;
from the set of candidate job postings selecting a presentation set based on:
respective relevance values generated for each job posting from the larger set of job postings with respect to each member profile from the set of member profiles, and
a predetermined jobs cap value indicating the maximum number of job postings that is to be selected for presentation to a member represented by a profile from the set of member profiles; and
causing presentation, on a display device, of a reference to a job posting from the presentation set.
